(19) United States
(12) Patent Application Publication
(10) Pub. No.: US 2013/0107449 A1
(43) Pub. Date: May 2, 2013

(54) Tablet computer enclosure

(71) Applicants: Yuan Zi Su, Jiangmen City (CN); Wai Keung Yeung, Tsuen Wan (HK); Timothy T. Chaing, Fountain Valley, CA (US)

(72) Inventors: Yuan Zi Su, Jiangmen City (CN); Wai Keung Yeung, Tsuen Wan (HK); Timothy T. Chaing, Fountain Valley, CA (US)

(21) Appl. No.: 13/317,814

(22) Filed: Oct. 28, 2011

(51) Int. Cl. G06F 1/16

(52) U.S. Cl. 361/679.56

(57) ABSTRACT

A tablet computer enclosure (TCE) that functions in combination with a tablet computer. The TCE includes a back plate that is surrounded by a frame to form a front-facing cavity that is dimensioned to fit over the rear surface of the computer. Rotatably attached to the rear surface of the back plate is a TCE attachment arm that can be placed in a retracted position when not in use, or in an extended functional position. When in the extended position the TCE attachment arm can be inserted into an arm insertion slot located on a TCE attachment unit that is disclosed in three designs: a vehicle headrest attachment unit, a shelf attachment unit and a flat surface attachment unit. The TCE also includes an electrical power distribution and charging circuit that allows power to be applied to the tablet computer via the TCE.

### TECHNICAL FIELD

The invention generally pertains to computer mounting assemblies and more particularly to a tablet computer enclosure (TCE). The TCE has attached a retractable TCE attachment arm that when extended can be used as a computer stand or can be inserted into a plurality of TCE attachment units.

### BACKGROUND ART

A search of the prior art did not disclose any literature, applications or patents that read directly on the claims of the instant invention. However, the following publications are considered related:

| APPLICATION NO. | INVENTOR | ISSUED |
|---|---|---|
| PCT/CN 2010/078506 | Yuan Zi Su | unavailable |
| PCT/CN 2009/071990 | Yuan Zi Su | unavailable |
| PCT/CN 2009/071989 | Yuan Si Su | unavailable |

### DISCLOSURE OF THE INVENTION

The tablet computer enclosure (TCE), also referred to by the trademark inCarBite™, is designed to be releasably attached to the rear surface of a tablet computer such as an Apple iPad™. In its basic design configuration, the TCE is comprised of:

A. A back plate surrounded by a frame that together form a front-facing cavity that interfaces with the rear surface of the tablet computer,

B. A set of openings and protrusions located on the back plate and the frame that are aligned with a corresponding set of openings and protrusions located on the tablet computer,

C. A TCE attachment arm rotatably attached to a lower section of the frame. The

TCE attachment arm is designed to be placed in either a retracted position or in an extended position,

D. A TCE attachment unit having an arm insertion slot dimensioned to receive and secure the extended TCE attachment arm, and

E. An electrical power distribution and charging circuit.

The TCE attachment unit is disclosed in three designs namely, a vehicle headrest attachment unit (VHAU), a shelf attachment unit (SAU), and a flat surface attachment unit (FSAU).

The VHAU is attached to a pair of vertical headrest rods that extend from either a vehicle driver-side seat or from a passenger-side seat, and consist of a rear-facing structure and a front-facing structure.

The rear-facing structure has an arm insertion slot having means for accepting and securing the TCE attachment arm. The front facing structure has means for gripping the vertical headrest rods and for being attached to the rear facing structure.

The SAU has an upper shelf mounting plate and a lower rotatable structure. The mounting plate has means for being attached to a lower surface of a shelf, and the lower structure has means for being rotatably attached to the upper shelf mounting plate. The lower rotatable structure includes an arm insertion slot having means for accepting and receiving the TCE attachment arm.

The FSAU has a lower enclosure and an upper rotatable structure. The lower enclosure has a lower surface that is designed to be placed on a flat horizontal surface such as a tabletop. The lower enclosure can also be designed to enclose an AM and FM receiver that is connected to a set of internal loudspeakers. The controls to operate the receiver are accessed from the side of the lower enclosure.

The upper rotatable structure has means for being rotatably attached to the lower enclosure and also includes an arm attachment slot having means for accepting and securing the TCE attachment arm.

The electrical power distribution and charging circuit is designed to apply the required power levels to the tablet computer via the TCE. The circuit is also utilized to charge the computer battery.

In view of the above disclosure the primary object of the invention to provide a TCE that is practical, has an aesthetic appearance and that enhances the utility of a tablet computer.

In addition to the primary object of the invention it is also an object of the invention to provide a TCE that:
can be produced in a variety of colors,
is portable,
can be dimensioned to accommodate a variety of tablet computers,
is easily cleaned and cared for,
can include various forms of indicia,
protects the tablet computer, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic view of a tablet computer enclosure (TCE) prior to being attached to the rear surface of a tablet computer. The tablet computer is shown in broken lines for illustrative purposes only and forms no part of the claimed invention.

FIG. 2 is an elevational view of a front-facing cavity which is an element of the TCE.

FIG. 3 is an elevational view of a rear-protruding extension that extends from the back plate of the TCE.

FIG. 4 is an orthographic view of a tablet computer attached to the TCE and the TCE attached to a vehicle headrest attachment unit (VHAU).

FIG. 5 is an orthographic view of the rear surface of the back plate shown with an extended TCE attachment arm prior to being attached to the VHAU.

FIG. 6 is an orthographic view of the front surface of the TCE attached to a tablet computer and the TCE being attached to an exploded view of the VHAU.

FIG. 7 is a top plan view of an exploded VHAU and an extended TCE attachment arm prior to being attached to a VHAU.

FIG. 8 is a side elevational view of an exploded VHAU and an extended TCE attachment arm prior to being attached to a VHAU.

FIG. 9 is an orthographic view of a tablet computer attached to a TCE and with the TCE supported by a TCE attachment arm that functions as a stand.

FIG. 10 is an orthographic view showing the TCE attachment arm functioning as a TCE stand.

FIG. 11 is an orthographic view showing a TCE attachment arm being partly rotated into a functioning position.

FIG. 12 is an orthographic rear view of the TCE attachment arm prior to being inserted into a slot located on a shelf attachment unit (SAU).

FIG. 13 is an orthographic front view of the TCE attachment arm prior to being inserted into a slot located on a shelf attachment unit (SAU).

FIG. 14 is an orthographic front view showing the TCE attachment arm being inserted into a slot located on a flat surface attachment unit (FSAU).

FIG. 15 is an orthographic rear view showing the TCE attachment arm being inserted into a slot located on the FSAU.

FIG. 16 is an orthographic rear view of the FSAU showing the location of the arm insertion slot.

FIG. 17 is an orthographic front view of the FSAU showing the location of the controls that operate an internal AM/FM receiver.

FIG. 18 is a block diagram of a typical TCE power distribution and charging circuit.

### BEST MODE FOR CARRYING OUT THE INVENTION

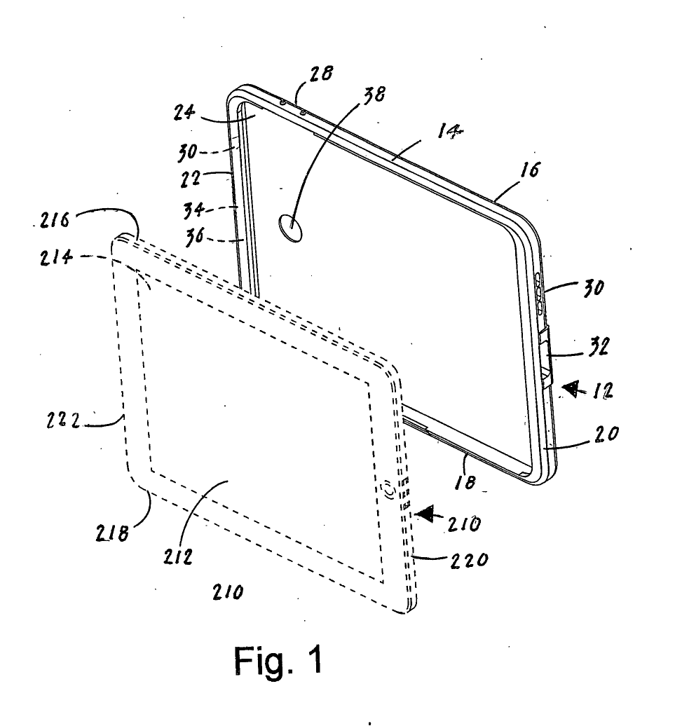

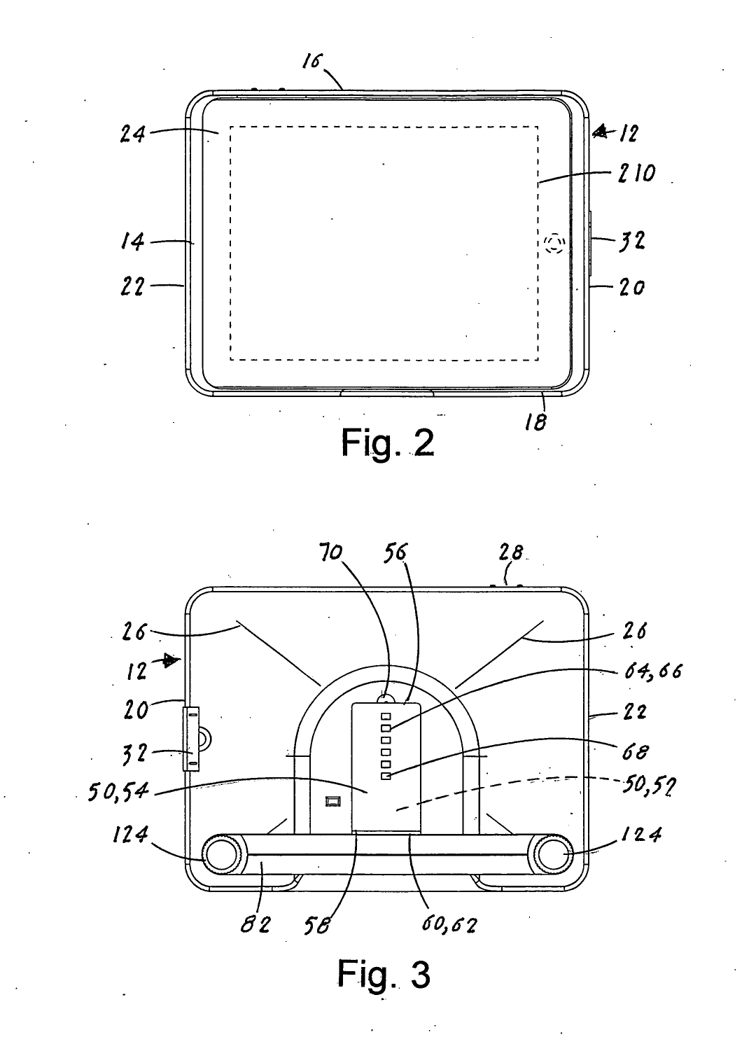

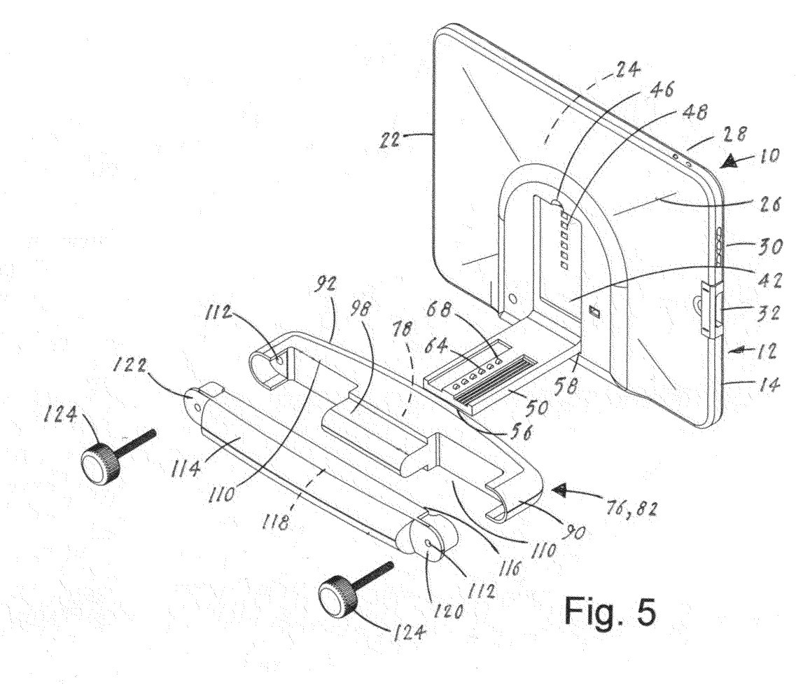

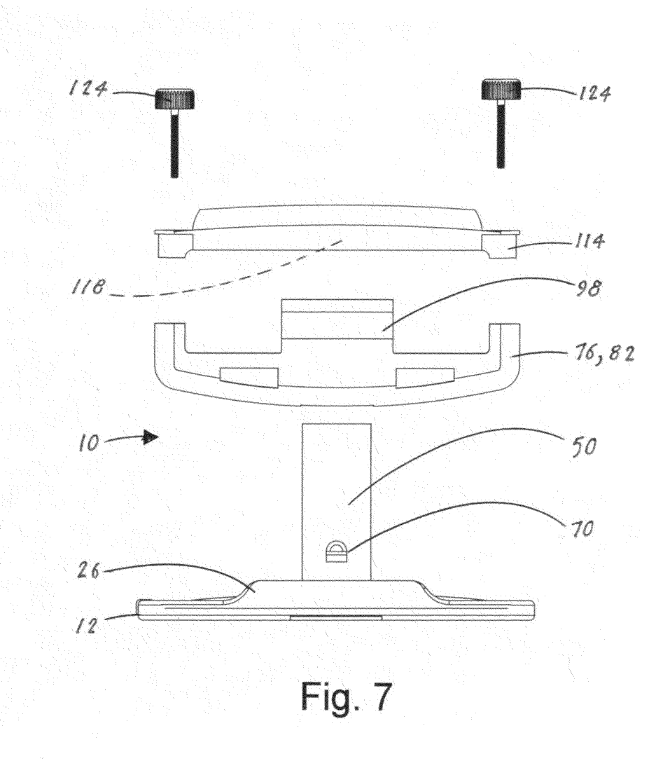

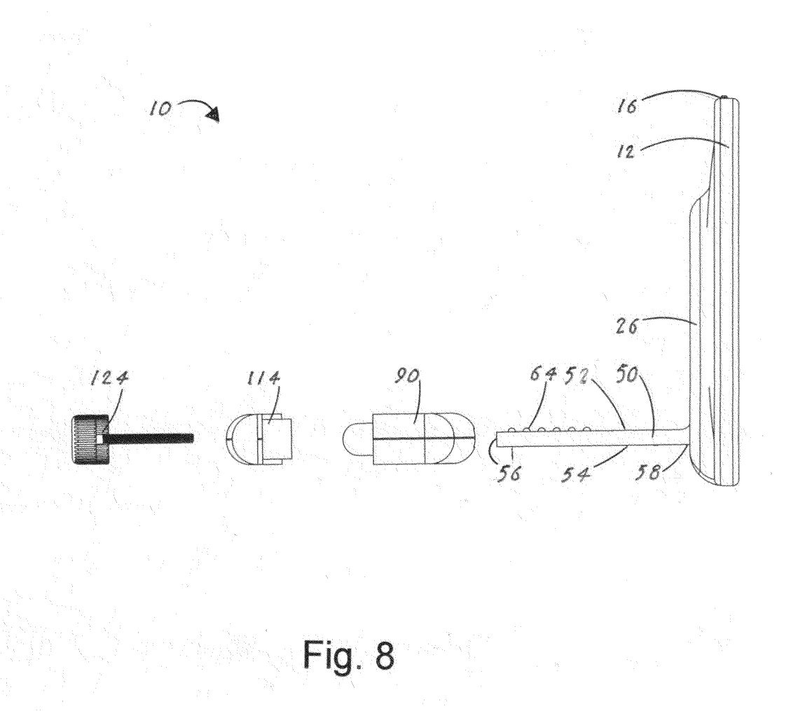

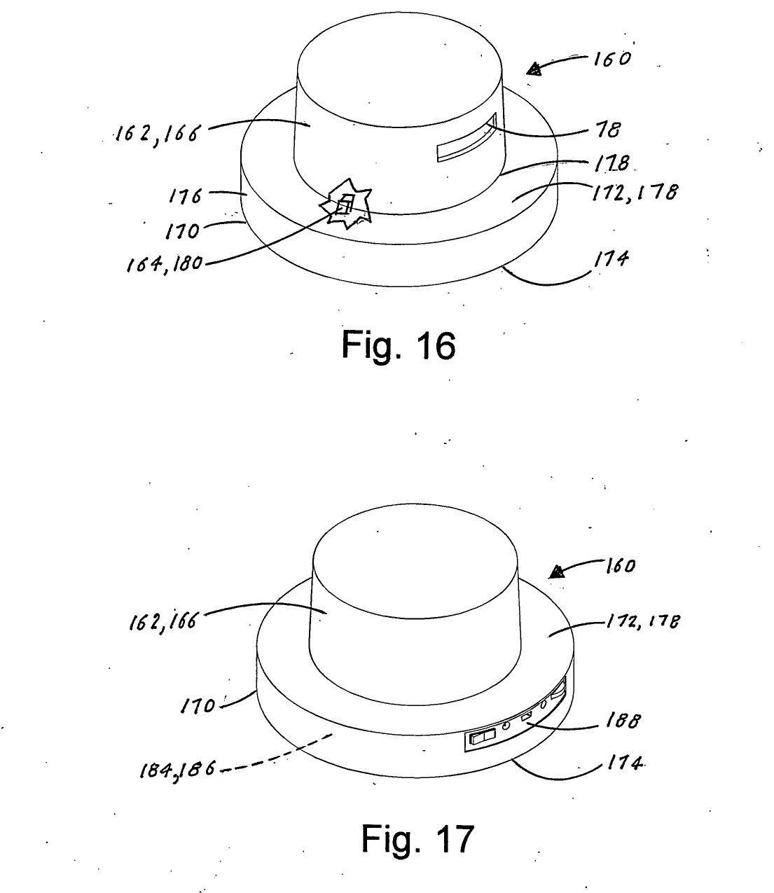

The best mode for carrying out the invention is presented in terms that disclose a preferred embodiment of a tablet computer enclosure 10 (TCE 10). The TCE 10, which is shown in FIGS. 1-18, is comprised of the following four major elements: a back plate 12, a TCE attachment arm 50, a TCE attachment unit 76 and a TCE electrical power distribution and charging circuit 190. The TCE attachment unit 76 is further disclosed in three design configurations: a vehicle headrest attachment unit (VHAU) 82, a shelf attachment unit (SAU) 126 and a flat surface attachment unit (FSAU) 160. The material used to construct the TCE 10 can be selected from the group consisting of plastic, metal, carbon fiber and wood.

The TCE 10 functions in combination with a tablet computer 210 having a front screen 212, a rear surface 214, an upper edge 216, a lower edge 218, a first side edge 220 and a second side edge 222. The tablet computer 210 is comprised of an Apple iPAD™ and the like.

The back plate 12, as shown in FIGS. 1, 2 and 3, is bordered by a frame 14 having an upper section 16, a lower section 18, a right section 20, a left section 22 and a rear-protruding extension 26. The frame 14 and the back plate 12 form a front facing cavity 24, as shown in FIG. 1, that is dimensioned to interface with the rear surface 214 of the tablet computer 210. The TCE 10 further has a pair of volume control pins 28, a set of three slots 30, a back plate release key 32, a power on/off button 34, an audio pin bore 36, a tablet releasing bore 38, and a TCE arm attachment cavity 42.

The pair of volume control pins 28 protrude from the upper section 16 of the frame 14 and are aligned with a corresponding pair of volume control switches located on the tablet computer 210. The set of three slots 30 are located on the right and left sections 20,22 of the frame 14 and function as loudspeaker audio outlets, the back plate release key 32 is located on the right section 20. The power on/off button 34 and the audio pin bore 36 are both located on the left section of the frame 14. The button 34 is aligned with a power on/off switch located on the tablet computer 210. Likewise, the audio pin bore 36 is aligned with an audio pin bore located on the tablet computer 210. The tablet releasing bore 38 is located on the back plate 12 and is dimensioned to allow a finger to enter the bore to allow finger pressure to be applied to the rear surface 214 of the tablet computer 210 when releasing the computer 210 from the TCE 10. The arm attachment cavity 42 is located On the back plate 12 and extends upward from the lower section 18 of the frame 14. The cavity 42 terminates at an upper terminus 44, has a finger grasping indentation 46, and a plurality of vertically-aligned pin engaging rollers 48.

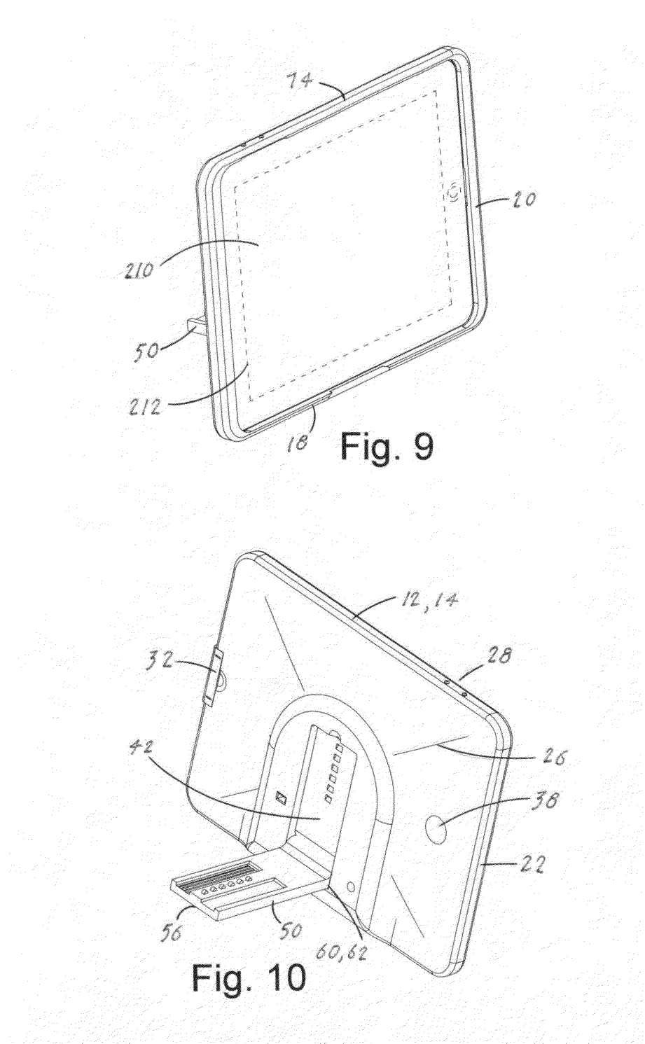

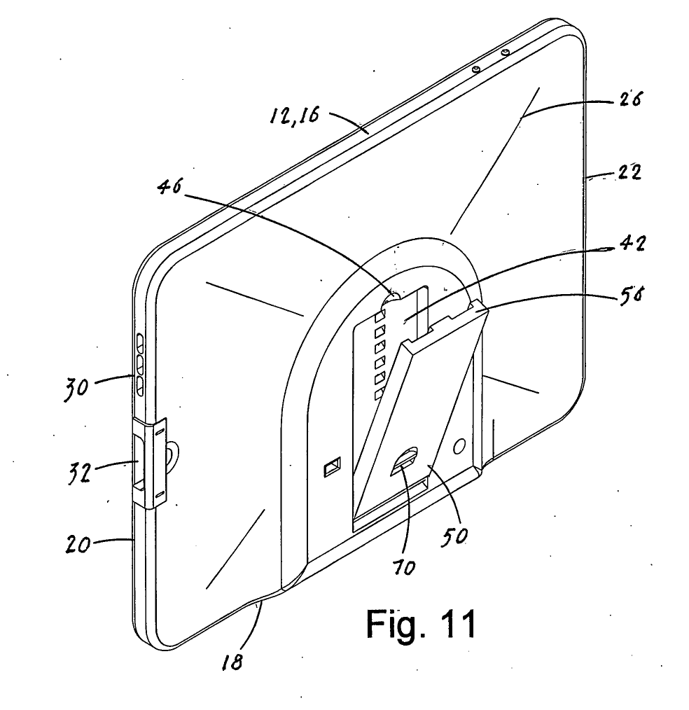

The TCE attachment arm 50, as shown in FIGS. 3, 5-8, includes an inward side 52 having a set of rollers 64, an outward side 54, an upper edge 56, and a lower edge 58. The outward side 54 has a spring-loaded tab 70, as shown in FIG. 3, that when activated by finger-applied pressure, the rollers 64 retract to facilitate the insertion of the TCE attachment arm 50 into an arm insertion slot 78. The lower edge 58 of the arm 50 is rotatably and frictionally attached by an attachment means 60 to the lower section 18 of the frame 14. The attachment means 60 is typically comprised of a friction structure 62 consisting of an interfacing cylinder and rod combination. The TCE attachment arm 50 further has on its inward side 52 a plurality of vertically aligned rollers 64. The rollers 64 are rotatably attached by pins 66 that are located within a plurality of cavities 68 located within the arm attachment cavity 42. The rollers 64 interface with the corresponding cavities 68 as the attachment arm 50 is rotated upward when placing the attachment arm 50 in a retracted position, as shown in FIG. 3, and partly retraced as shown in FIG. 11. The attachment arm 50 is primarily designed to attach the back plate 12 to the TCE attachment unit 50. However, the attachment arm 50 can also be utilized as a TCE stand, as shown in FIGS. 9 and 10. The TCE attachment arm 50 also functions as one of the elements that comprise the electrical power distribution and charging circuit 190 described below.

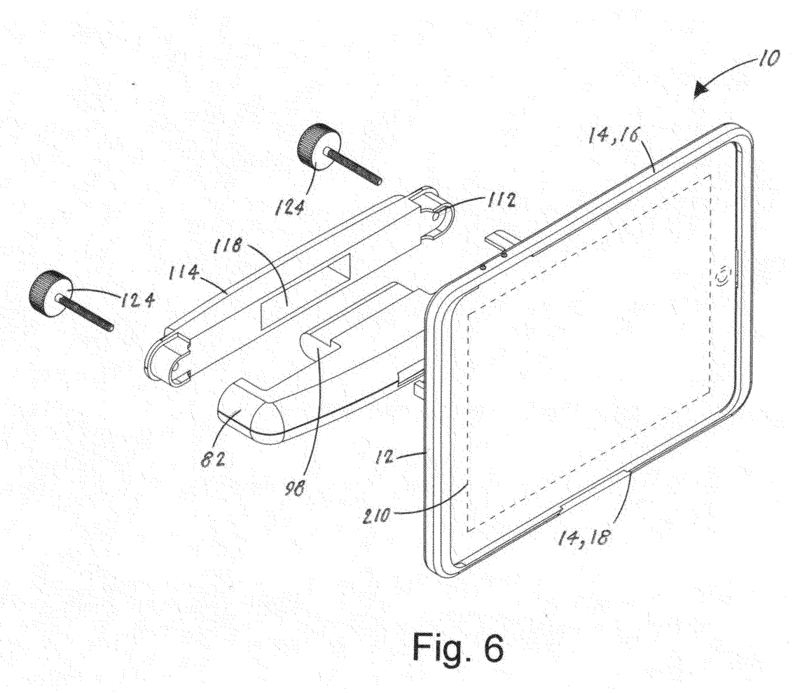

The basic design of the TCE attachment unit 76, as best shown in FIGS. 6, 14 and 15, includes an arm insertion slot 78 having a plurality of arm attachment cavities 80. The cavities 80 interface with the rollers 64 on the TCE attachment arm 50 when the TCE attachment arm 50 is inserted into the arm insertion slot 78. Various designs of the TCE attachment unit 76 can be utilized to practice the TCE 10. Three of the design configurations of the TCE attachment unit 76 as disclosed above, are further described.

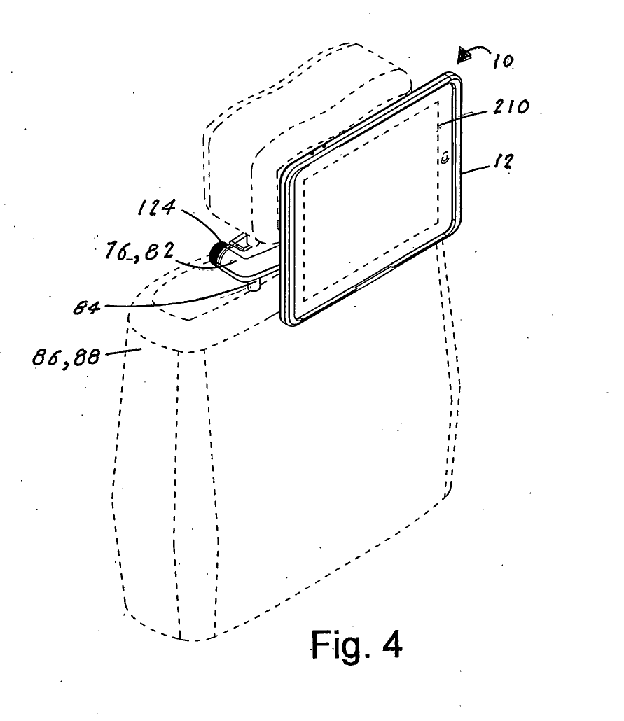

The vehicle headrest attachment unit (VHAU) 82 is designed to be attached to a pair of vertical headrest rods 84 that extend from either a driver-side seat 86 or from a passenger-side seat 88, as shown in FIGS. 4-8. The VHAU 82 is comprised of a rear facing structure 90, a front facing structure 114 and a pair of knurled hand-tightened bolts 124.

The rear facing structure 90 includes a front surface 92 having an arm insertion slot 78 further having a plurality of arm attachment cavities 94. The cavities 94 interface with the rollers 64 when the TCE attachment arm 50 is inserted into the arm insertion slot 78. The rear facing structure 90 also includes a protruding center section 98 that separates a pair of rod receiving slots 110 that interface with the pair of vertical headrest rods 84. The rear surface 116 of the front facing structure 114 has a cavity 118 that is dimensioned to receive the protruding center section 98 located on the rear facing structure 90. The front facing structure 114 also has a pair of end tabs 120 with each tab having a bore 122. The pair of hand tightened bolts 124 are inserted through the tab bores 122 and into the pair of threaded bores 112 located on the rear facing structure 90. When the bolts 124 are tightened the two VHAU structures 90,114 move inward to secure the TCE 10 to the headrest rods.

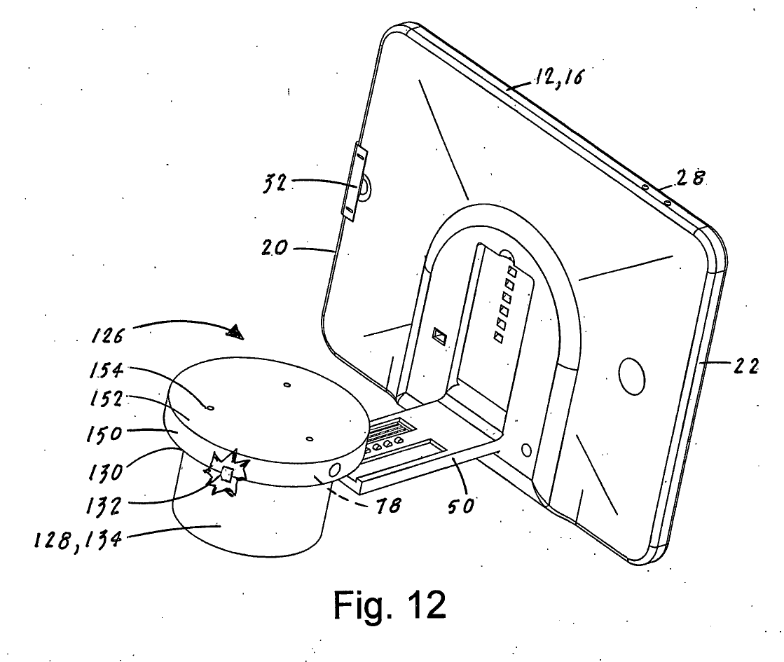

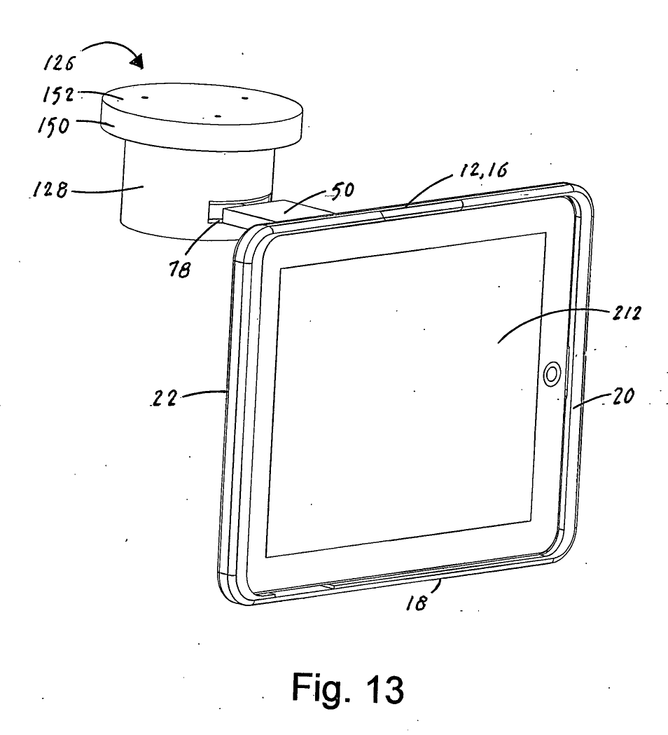

The shelf attachment unit 126 (SAU 126), as best shown in FIGS. 12 and 13, is designed to be attached to the lower surface of a shelf such as a kitchen shelf. The SAU 126 is comprised of a lower rotatable structure 128, and an upper shelf mounting plate 150.

The lower rotatable structure 128 includes an upper section 130 having a pair of stops 132 that limit its rotational travel to an arc of approximately 120-degrees. The structure 128 also has a side 134 that includes an arm insertion slot 78 having means for accepting and securing the TCE attachment arm 50 as previously described.

The upper shelf mounting plate 150 has an upper surface 152 that includes a shelf mounting means 154 for rotatably attaching the plate 150 to the structure 128. The shelf mounting means 154 is selected from the group consisting of screws, hook and loop fasteners, double-sided tape and an adhesive.

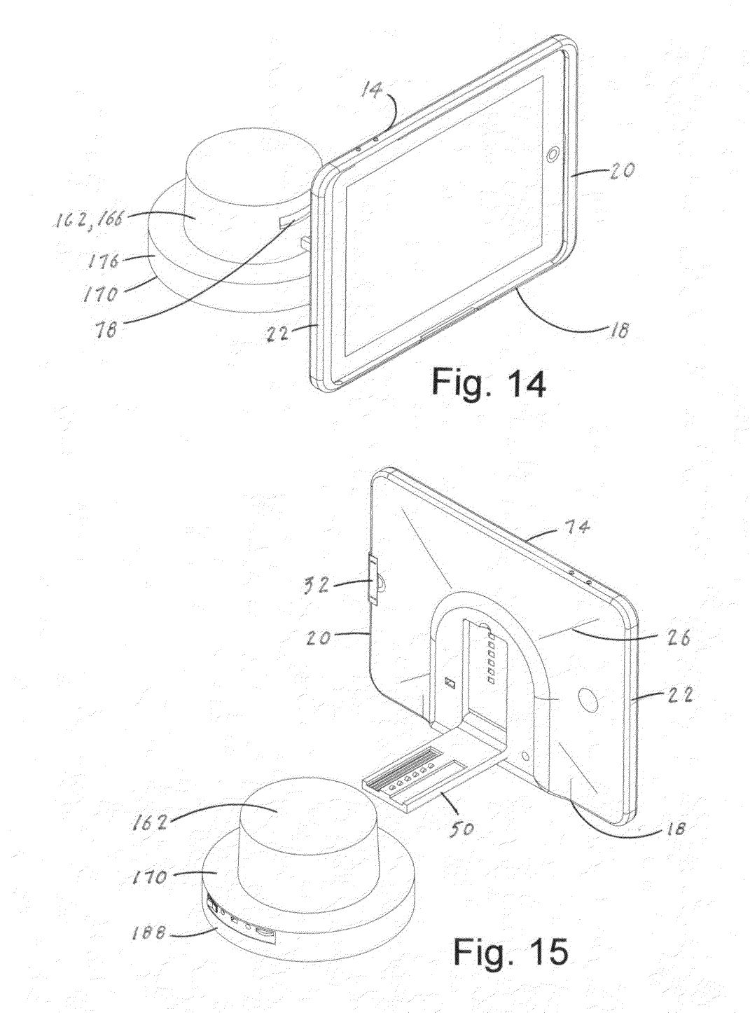

The flat surface attachment unit 160 (FSAU 160), as shown in FIGS. 14-17, is primarily designed to be placed on a flat surface such as a kitchen counter or table top. However, by rotating the FSAU 360-degrees, the FSAU 160 can also be attached to the lower surface of a shelf, such as a kitchen shelf. The FSAU 160 is comprised of an upper rotatable structure 162 and a lower stationary enclosure 170. The upper rotatable structure 162 has a side 166 and a pair of internal stops 164 that limit the rotational travel to approximately 120-degrees. The side 166 includes an arm insertion slot 78 and means 168 for accepting and securing the TCE attachment arm 50, as previously described.

The lower stationary enclosure 170 has an upper surface 172, a lower surface 174 and a side 176. The upper surface 172 has means 178 for being attached to the upper rotatable structure 162. The lower surface 174 also has a pair of internal stops 180 that abut against the stops 164 on the upper rotatable structure 162. The FSAU 160 features an AM and FM receiver 184 that is located within the confines of the lower stationary enclosure 170. The AM and FM receiver 184 is connected to a set of loudspeakers 186 that produce the audio through the three slots 30 located on the right and left sections 20,22 of the frame 14. The controls 188 to operate the receiver 184 are accessed from the side 176 of the lower stationary enclosure 170.

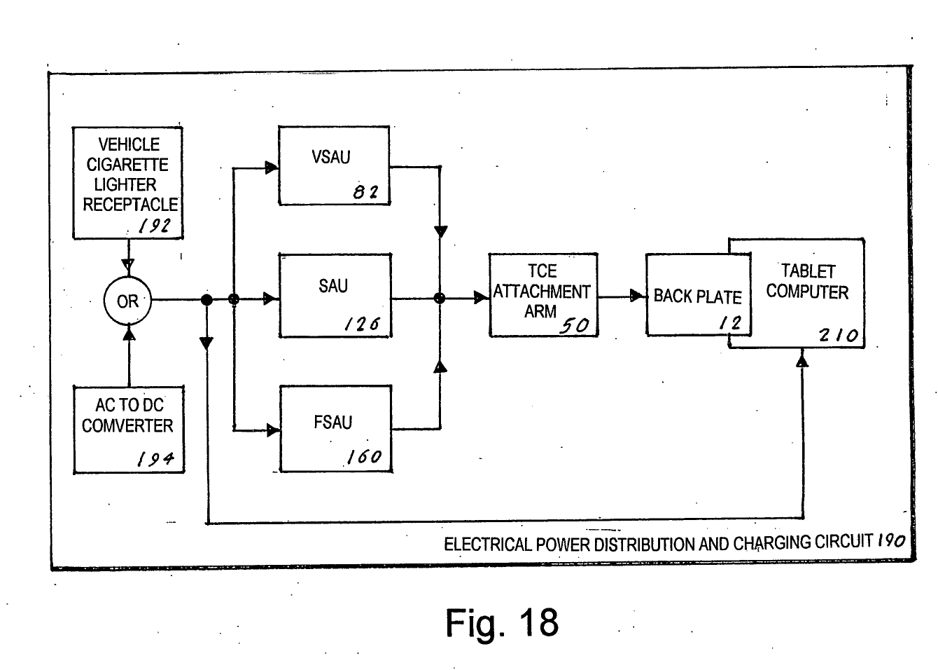

The power distribution and charging circuit 190, as shown in FIG. 18, is typically comprised of the following elements: a vehicle cigarette lighter receptacle 192, an a-c to d-c converter 194, the VHAU 82, the SAU 126, or the FSAU 160, the TCE attachment arm 50, the back plate 12 and the tablet computer 210.

The vehicle cigarette lighter receptacle 192 or the a-c to d-c converter 194 each produce a 12-volt d-c voltage that is applied through either the VHAU 82, the SAU 126 or the FSAU 160. The 12-volts d-c is further applied sequentially through the TCE attachment arm 50, the back plate 12 and to the tablet computer 210. Optionally, the 12-volts d-c from the vehicle cigarette lighter receptacle 192 or the a-c to d-c converter 194 can be applied directly to a power charging receptacle located on the tablet computer 210.

While the invention has been described in detail and pictorially shown in the accompanying drawings it is not to be limited to such details, since many changes and modifications may be made to the invention without departing from the spirit and the scope thereof. Hence, the TCE is described to cover any and all modification and forms which may come within the language and scope of the claims.

### Tablet Computer Enclosure

### Element Designation

### For Convenience of the Examiner, not Part of the Specification

| | | | |
|---|---|---|---|
| 10 | Tablet Computer Enclosure | 60 | Attachment Means |
| 12 | Back Plate | 62 | Friction Structure |
| 14 | Frame | 64 | Rollers |
| 16 | Upper Section | 66 | Pins |
| 18 | Lower Section | 68 | Cavities |
| 20 | Right Section | 70 | Spring-Loaded Tab |
| 22 | Left Section | 72 | |
| 24 | Front-Facing Cavity | 74 | |
| 26 | Rear-Protruding Extension | 76 | TCE Attachment Unit |
| 28 | Volume Control Pins | 78 | Arm Insertion Slot |
| 30 | Three Slots | 80 | Arm Attachment Cavities |
| 32 | Back Plate Release Key | 82 | Vehicle Headrest Attach Unit |
| 34 | Power On/Off Button | 84 | Vehicle Headrest Rods |
| 36 | Audio Pin Bore | 86 | Driver-Side Seat |
| 38 | Tablet Releasing Bore | 88 | Passenger-Side Seat |
| 40 | | 90 | Rear Facing Structure |
| 42 | Arm Attachment Cavity | 92 | Front Surface |
| 44 | Upper Terminus | 94 | Arm Attachment Cavities |
| 46 | Finger Gripping Indentation | 96 | |
| 48 | Rollers | 98 | Protruding Center Section |
| 50 | TCE Attachment Arm | 110 | Rod Receiving Slots |
| 52 | Inward Side | 112 | Pair of Threaded Bores |
| 54 | Outward Side | 114 | Front Facing Structure |
| 56 | Upper Edge | 116 | Rear Surface |
| 58 | Lower Edge | 118 | Cavity |
| 120 | End Tabs | 182 | |
| 122 | Bore | 184 | AM and FM Receiver |
| 124 | Hand Tightened Bolts | 186 | Loudspeaker |
| 126 | Shelf Attachment Unit (SAU) | 188 | Controls |
| 128 | Lower Rotatable Structure | 190 | Electrical Power Dist. & |
| | | | Charging Cir. |
| 130 | Upper Section | 192 | Vehicle Cigarette |
| | | | Lighter Receptacle |
| 132 | Stops | 194 | A-C to D-C Converter |
| 134 | Side | 196 | |
| 136 | | 198 | |
| 138 | | 210 | Tablet Computer |
| 140 | | 212 | Front Screen |
| 142 | | 214 | Rear Surface |
| 144 | | 216 | Upper Edge |
| 146 | | 218 | Lower Edge |
| 148 | | 220 | First Side Edge |
| 150 | Upper Shelf Mounting Plate | 222 | Second Side Edge |
| 152 | Upper Surface | 224 | |
| 154 | Shelf Mounting Means | 226 | |
| 156 | | | |
| 158 | | | |
| 160 | Flat Surface Attachment Unit | | |
| | (FSAU) | | |
| 162 | Upper Rotatable Structure | | |
| 164 | Internal Stops | | |
| 166 | Side | | |
| 168 | Means | | |
| 170 | Lower Stationary Enclosure | | |
| 172 | Upper Surface | | |
| 174 | Lower Surface | | |
| 176 | Side | | |
| 178 | Means | | |

1. A tablet computer enclosure (TCE) that is designed to be releasably attached over the rear surface of a tablet computer, said TCE having:
a) a back plate surrounded by a frame that together form a front-facing cavity that interfaces with the rear surface of the tablet computer,
b) a set of openings and protrusions located on the back plate and the frame that are aligned with a corresponding set of openings and protrusions located on the tablet computer,
c) a TCE attachment arm rotatably attached to a lower section of the frame, wherein said TCE attachment arm can be placed in a retracted position or in an extended functional position,
d) a TCE attachment unit having an arm insertion slot dimensioned to receive and secure the extended said TCE attachment arm, and
e) an electrical power distribution and charging circuit designed to apply the required power levels to operate the tablet computer via said TCE.

2. The TCE as specified in claim 1 wherein said TCE attachment unit is comprised of a vehicle headrest attachment unit that attaches to a pair of vertical headrest rods that extend from either a driver-side seat or from a passenger-side seat, said unit having:
a) a rear facing structure having an arm insertion slot having means for accepting and securing said TCE attachment arm, and
b) a front facing structure having means for gripping the vertical headrest rods and for being attached to the rear facing structure.

3. The TCE as specified in claim 1 wherein said TCE attachment unit is comprised of a shelf attachment unit having:
a) an upper shelf mounting plate having means for being attached to a lower surface of the shelf, and
b) a lower rotatable structure having means for being attached to the upper mounting plate, and
c) an arm insertion slot having means for accepting and receiving said attachment arm.

4. The TCE as specified in claim 1 wherein said TCE attachment unit is comprised of a flat surface attachment unit having:
a) a lower enclosure having:
(1) a lower surface designed to be placed on a flat horizontal surface,
(2) an AM and FM receiver connected to a set of internal loud speakers, wherein the controls to operate the receiver are accessed from the side of the lower enclosure, and
b) an upper rotatable structure having means for being rotatably attached to the lower enclosure and that includes an arm attachment slot having means for accepting and securing said attachment arm.

5. The TCE as specified in claim 4 wherein the lower enclosure can be rotated 360-degrees to allow the lower enclosure to be also attached to the lower surface of a shelf.

6. The TCE as specified in claim 1 wherein said adjustable TCE attachment arm can be positioned to be utilized as a TCE stand.

7. The TCE as specified in claim 1 wherein said TCE attachment arm further comprises a finger-actuated tab that when actuated a set of rollers located on said TCE attachment arm retract when said TCE attachment arm is being inserted into the arm insertion slot.

8. A tablet computer enclosure (TCE) that functions in combination with a tablet computer having a front screen, a rear surface, an upper edge, a lower edge, a first side edge and a second side edge, said TCE comprising:
a) a back plate bordered by a frame having an upper section, a lower section, a right section, a left section and a rear-protruding extension, wherein the frame and the back plate form a front-facing cavity dimensioned to interface with the rear surface of the tablet computer, said TCE further having:
(1) a pair of volume control pins that protrude from the upper section of said frame and that are aligned with a pair of volume control switches located on the tablet computer,
(2) a set of three slots located on the right and left sections of said frame, wherein the slots function as loudspeaker audio outlets,
(3) a power on/off button and an audio pin bore both located on the left section of said frame, wherein the button is aligned with a power on/off switch located on the tablet computer, and the audio pin bore is aligned with an audio pin located on the tablet computer,
(4) a tablet releasing bore located on said back plate that allows finger pressure to be applied to the rear surface of the tablet computer when releasing the tablet computer from the TCE,
(5) an arm attachment cavity located on the back plate and that extends upward from the lower section of said frame and that terminates at an upper terminus having a finger grasping indentation, the cavity further having a plurality of vertically aligned roller engaging cavities,
b) a TCE attachment arm having an inward side, an outward side, an upper edge and a lower edge that is rotatably and frictionally attached by an attachment means to the lower section of the frame, wherein said TCE attachment arm further having on the inward side a plurality of vertically aligned rollers that interface with a plurality of the roller engaging cavities located on the arm attachment cavity when said TCE attachment arm is rotated upward to be placed in a retracted position,
c) a TCE attachment unit having an arm insertion slot having a plurality of arm attachment cavities that interface with the rollers, when said attachment arm is inserted into the arm insertion slot, and
d) an electrical power distribution and charging circuit.

9. The TCE as specified in claim 8 wherein said TCE is designed for use with tablet computers such as an Apple iPAD®.

10. The TCE as specified in claim 8 wherein said TCE is made of a material selected from the group consisting of plastic, metal, carbon fiber and wood.

11. The TCE as specified in claim 10 wherein the tablet releasing bore is dimensioned to allow a person's finger to enter the bore.

12. The TCE as specified in claim 8 wherein said the back plate further comprises a rear-protruding extension that provides space for including the arm attachment cavity.

13. The TCE as specified in claim 8 wherein said means for rotatably and frictionally attaching the TCE attachment arm comprises a friction structure.

14. The TCE as specified in claim 13 wherein the inward side of said TCE attachment arm further comprises a plurality of vertically aligned cavities having pins that rotatably attach the rollers.

15. The TCE as specified in claim 14 wherein the outward side of said TCE attachment arm further comprises a finger actuated tab that retracts the rollers when said TCE attachment arm is being inserted into the arm insertion slot.

16. The TCE as specified in claim 8 wherein said TCE attachment unit is comprised of a vehicle headrest attachment unit (VHAU) that attaches to a pair of vertical headrest rods that extend from either a driver-side seat or from a passenger-side seat, wherein said VHAU further comprises:
a) a rear-facing structure having:
(1) a front surface further having an arm insertion slot having a plurality of arm attachment cavities that interface with the rollers when said TCE attachment arm is inserted into the arm insertion slot,
(2) a rear surface having a protruding center section that separates a pair of rod receiving slots that interface with the pair of vertical headrest rods, and
(3) a pair of threaded bores,
b) a front facing structure having:
(1) a rear surface having a cavity dimensioned to receive the protruding center section on said rear facing structure,
(2) a pair of end tabs each having a bore, and
c) a pair of hand-tightened bolts that are inserted through the tab bores and into the pair of threaded bores on said front facing structure, wherein when the bolts are tightened the two VHAU structures move inward to secure the TCE to the headrest.

17. The TCE as specified in claim 8 wherein said TCE attachment unit is comprised of a shelf attachment unit (SAU) comprising:
a) a lower rotatable structure having:
(1) an upper section that includes a pair of stops that limit the rotational travel,
(2) a plurality of bores, and
(3) a side having an arm insertion slot having means for accepting and securing said TCE attachment arm, and
b) an upper shelf mounting plate having a shelf mounting means for attaching said SAU to the lower surface of the shelf.

18. The TCE as specified in claim 17 wherein said shelf mounting means is selected from the group consisting of screws, hook and loop fasteners, double-sided tape and an adhesive.

19. The TCE as specified in claim 8 wherein said TCE attachment unit is comprised of a flat surface attachment unit (FSAU) comprising:
a) an upper rotatable structure having:
(1) a pair of internal stops that limit the rotational travel,
(2) a side that includes an arm attachment slot having means for accepting and securing said TCE attachment arm,
b) a lower enclosure having:
(1) an upper surface, a lower surface and a side, wherein the upper surface having means for being attached to said upper rotatable structure,
(2) a pair of internal stops that abut against the stops on the upper rotatable structure, and
(3) an AM and FM receiver connected to a set of loudspeakers, wherein the controls to operate the receiver are accessed from the side of the lower enclosure.

20. The TCE as specified in claim 8 wherein said electrical power distribution and charging circuit comprises: a 12-volt d-c voltage provided by either a vehicle cigarette lighter receptacle or an a-c to d-c converter, wherein the 12-volt d-c voltage is applied through either a VHAU, an SAU or a SFAU from where the 12-volt d-c is applied sequentially through said TCE attachment arm, the back plate and to the tablet computer, wherein optionally the 12-volt d-c voltage applied from either the vehicle cigarette lighter receptacle or the a-c to d-c converter can be applied directly to the tablet computer.
